(19) United States
(12) Patent Application Publication
(10) Pub. No.: US 2020/0243208 A1
(43) Pub. Date: Jul. 30, 2020

(54) CIRCULATING-FUEL NUCLEAR REACTOR

(71) Applicant: ROLLS-ROYCE plc, London (GB)

(72) Inventor: Olga NEGRI, Derby (GB)

(21) Appl. No.: 16/744,291

(22) Filed: Jan. 16, 2020

(30) Foreign Application Priority Data
Jan. 25, 2019 (GB) 1901026.3

(51) Int. Cl. G21C 1/22; G21C 15/243; G21C 15/06

(52) U.S. Cl. CPC G21C 1/22; G21C 15/06; G21C 15/243

(57) ABSTRACT

A circulating-fuel nuclear reactor comprising: a reactor core chamber having an inlet and an outlet for fluid fuel; a heat exchanger configured to receive fluid fuel from the reactor core chamber via the outlet, to transfer heat from the fluid fuel, and to return the fluid fuel to the reactor core chamber via the inlet; a flow regulator operable to vary an operational flow rate of fluid fuel through the heat exchanger; and a control module configured to cause the flow regulator to vary the operational flow rate of fluid fuel through the heat exchanger to maintain an operational temperature of the fluid fuel within a predetermined range.

### CROSS-REFERENCE TO RELATED APPLICATIONS

This specification is based upon and claims the benefit of priority from United Kingdom patent application number GB 1901026.3 filed on Jan. 25, 2019, the entire contents of which are incorporated herein by reference.

### BACKGROUND

### Field of the Disclosure

The present disclosure concerns circulating-fuel nuclear reactors and methods of operating circulating-fuel nuclear reactors.

### Description of the Related Art

Circulating-fuel nuclear reactors make use of fluid, rather than solid fuels containing fissile material. Molten Salt Reactors (MSRs) in particular employ liquid (i.e. molten) salts both as fuels and as coolants. The molten fuel salt is generally circulated between a reactor core chamber, in which the nuclear chain reaction takes places, and one or more heat exchangers, where heat is transferred from the molten fuel salt to the coolant salt for subsequent transfer to a generator for generation of electricity. Examples of MSRs include the Molten Salt Fast Reactor (MSFR), the Molten Salt Actinide Recycler and Transmuter (MOSART), the ThorCon molten salt reactor and the FUJI molten salt reactor. The MSFR and the MOSART reactors make use of fast, rather than thermal, neutrons, and are therefore examples of unmoderated MSRs. In contrast, the ThorCon and FUJI reactors are moderated MSRs which make use of thermal neutrons.

Benefits of circulating-fuel nuclear reactors over conventional solid-fuel reactors include the possibilities of online refueling, online fuel reprocessing, improved heat transfer efficiencies and higher operating temperatures. However, criticality control in circulating-fuel nuclear reactors can be challenging. Proposed criticality control methods include ongoing active control though online fuel salt reprocessing, including removal of fission products such as noble gases and soluble lanthanides and introduction of new fissile material and emergency criticality control through use of melt plugs in combination with emergency drain tanks. There are a number of drawbacks associated with these proposed criticality control methods such that the provision of new criticality control methods is desirable.

### SUMMARY OF THE DISCLOSURE

According to a first aspect, there is provided a circulating-fuel nuclear reactor comprising: a reactor core chamber having an inlet and an outlet for fluid fuel; a heat exchanger configured to receive fluid fuel from the reactor core chamber via the outlet, to transfer heat from the fluid fuel, and to return the fluid fuel to the reactor core chamber via the inlet; a flow regulator operable to vary (e.g. increase or reduce) an operational flow rate of fluid fuel through the heat exchanger; and a control module configured to cause the flow regulator to vary (e.g. increase or reduce) the operational flow rate of fluid fuel through the heat exchanger to maintain an operational temperature of the fluid fuel within a predetermined range.

It will be appreciated that the temperature of the fluid fuel in the circulating-fuel nuclear reactor may be different in different locations within the circulating-fuel nuclear reactor. For example, the temperature of the fluid fuel exiting the heat exchanger (and entering the reactor core chamber) at the inlet is generally lower than the temperature of the fluid fuel entering the heat exchanger (and exiting the reactor core chamber). The temperature of the fluid fuel in the circulating-fuel nuclear reactor generally increases due to fissioning of fissile material in the fluid fuel as the fluid fuel flows through the reactor core chamber from the inlet to the outlet. Accordingly, the operational temperature of the fluid fuel (which is to be maintained within the predetermined range) may be the temperature of the fluid fuel at any particular location within the circulating-fuel nuclear reactor, for example a temperature at a particular monitored location. Alternatively, the operational temperature of the fluid fuel may be an averaged temperature of the fluid fuel, such as an average temperature of the fluid fuel in the reactor core chamber (e.g. the average of the temperature of the fluid fuel at the inlet and the temperature of the fluid fuel at the outlet).

Varying the operational flow rate of fluid fuel through the heat exchanger has been found to affect the operational temperature of the fluid fuel in the nuclear reactor. Without wishing to be bound by theory, the operational temperature of the fluid fuel in the nuclear reactor is understood to be affected by changes in the operational flow rate of the fluid fuel by at least two different mechanisms. In a first mechanism, as the operational flow rate of fluid fuel through the heat exchanger is increased, the temperature of the fluid fuel exiting the heat exchanger increases, since less heat is transferred per unit volume of fluid fuel passing through in the heat exchanger (owing to shorter residence time in the heat exchanger). In a second mechanism, as the operational flow rate of fluid fuel through the heat exchanger is increased, fluid fuel moves more quickly through the reactor core chamber between the inlet and the outlet such that a reactor core chamber residence time for each unit volume of fluid fuel for each flow cycle is reduced and consequently less heat is generated through fission reactions, leading to an effective reduction in the temperature of the fluid fuel reaching the outlet of the reactor core chamber.

Reaction conditions in the reactor core chamber and the temperature of the fluid fuel are generally interdependent. For example, an increase in the rate of the nuclear reaction in the reactor core chamber tends to cause an increase in the temperature of the fluid fuel in the reactor core chamber, as heat is generated through fissioning of fissile material in the fluid fuel. The rate of the nuclear reaction can be characterised by k_{eff}, which is the effective neutron multiplication factor, i.e. the average number of neutrons produced in one fission event which cause a subsequent fission. k_{eff} may be calculated using, for example, the well-known six factor formula.

In addition, an increase in the temperature of the fluid fuel in the reactor core chamber tends to cause a slowdown in the nuclear reaction, as the reactivity of the fluid fuel generally exhibits a negative temperature dependence. More precisely, the temperature coefficient of reactivity of the fluid fuel, α_{T}, may be defined as:

$${α}_{T} = \frac{\partial ρ}{\partial T}$$

where T is the temperature and p is the reactivity defined by:

$$ρ = \frac{( {k}_{eff} - 1 )}{{k}_{eff}}$$

The temperature coefficient of reactivity, α_{T}, of the fluid fuel is generally negative such that an increase in temperature causes a reduction in the effective neutron multiplication factor, leading to a reduction in neutron flux, a reduction in reactor power, and consequently a reduction in temperature.

The inventors propose to maintain the operational temperature of the fluid fuel within the predetermined range so as to maintain criticality of the nuclear reaction in the reactor core chamber. The bounds of the predetermined range may therefore be determined so as to avoid excessive supercriticality (which may lead to an uncontrolled supercritical chain reaction) or excessive subcriticality (which may lead to reduced power output or reactor shutdown). Additionally or alternatively, the bounds of the predetermined range may be determined so as to avoid physical or chemical changes in the fluid fuel or in other reactor components which have a negative effect on the power output by the reactor. For example, the bounds of the predetermined range may be determined so as to avoid the operational temperature of the fluid fuel reaching or falling below the melting temperature or reaching or exceeding the melting point of materials used in the construction of components housing the fluid fuel.

Accordingly, the control module may be configured to cause the flow regulator to vary (e.g. increase or reduce) the operational flow rate of fluid fuel through the heat exchanger, to maintain an operational temperature of the fluid fuel within a predetermined range, in response to a change in reaction conditions in the reactor core chamber. In particular, the control module may be configured to cause the flow regulator to vary (e.g. increase or reduce) the operational flow rate of fluid fuel through the heat exchanger (i.e. in response to the change in reaction conditions in the reactor core chamber) in order to maintain predetermined reaction conditions, for example to mitigate against or to compensate for the change in reaction conditions.

The operational temperature of the fluid fuel is generally dependent on reaction conditions in the reactor core chamber. It may therefore be that the circulating-fuel nuclear reactor further comprises a sensor module operable to measure a parameter indicative of reaction conditions in the reactor core chamber. It may be that the control module is configured to cause the flow regulator to vary (e.g. increase or reduce) the operational flow rate of fluid fuel through the heat exchanger in response to detecting a change in reaction conditions in the reactor core chamber based on an output from the sensor module. The output from the sensor module may be a signal representative of (e.g. encoding) the parameter indicative of reaction conditions in the reactor core chamber. The parameter indicative of reaction conditions in the reactor core chamber may, for example, be: a temperature of the fluid fuel in the reactor core chamber, at the inlet, or at the outlet; an average temperature of the fluid fuel in the reactor chamber; a power output by the circulating-fuel nuclear reactor; an effective neutron multiplication factor, k_{eff}, or a reactivity, p; a neutron dose; a neutron flux; a fission rate in the reactor core chamber; a density of the fluid fuel circulating in the reactor; or a composition of the fluid fuel (such as a level, e.g. concentration, of one or more components of the fluid fuel) circulating in the reactor.

The sensor module may comprise one or more of the following: a temperature sensor (e.g. a high-temperature thermocouple); a radiation detector, for example a particle detector such as a neutron detector (e.g. a proportional counter, a fission chamber such as a uranium fission chamber, a self-powered neutron detector, a MicroMegas detector, a liquid scintillation detector, an ionization chamber); a calorimeter; a mass flow rate sensor (e.g. a Coriolis flow meter, which may function as a density sensor); a volume flow rate sensor; a chemical sensor (e.g. a spectrometer).

It may be that the sensor module is operable to measure a parameter indicative of reaction kinetics in the reactor core chamber. The parameter indicative of reaction kinetics in the reactor core chamber may be a parameter indicative of, or indeed may be, the effective neutron multiplication factor, k_{eff}, or the reactivity, p. It may be that the control module is configured to cause the flow regulator to vary (e.g. increase or reduce) the operational flow rate of fluid fuel through the heat exchanger in response to detecting a change in the reaction kinetics (e.g. a slowdown or speedup in the nuclear reaction) in the reactor core chamber. For example, it may be that the control module is configured to cause the flow regulator to increase the operational flow rate of fluid fuel through the heat exchanger in response to detecting a slowdown in the nuclear reaction in the reactor core chamber based on an output from the sensor module. Alternatively, it may be that the control module is configured to cause the flow regulator to reduce the operational flow rate of fluid fuel through the heat exchanger in response to detecting a speedup in the nuclear reaction in the reactor core chamber based on an output from the sensor module. Increasing the operational flow rate of the fluid fuel tends to cause an increase in the temperature of the fluid fuel at the inlet, which in turn tends to cause a reduction in k_{eff}. In contrast, reducing the operational flow rate of the fluid fuel tends to cause a reduction in the temperature of the fluid fuel at the inlet, which in turn tends to cause an increase in k_{eff}. The output from the sensor module may be a signal representative of (e.g. encoding) the parameter indicative of reaction kinetics in the reactor core chamber.

It may be that the sensor module is operable to measure a parameter indicative of the operational temperature of the fluid fuel within the nuclear reactor. For example, it may be that the sensor module is operable to measure the operational temperature of the fluid fuel within the nuclear reactor. It may be that the control module is configured to cause the flow regulator to vary (e.g. increase or reduce) the operational flow rate of fluid fuel through the heat exchanger as a function of the operational temperature of the fluid fuel based on an output from the sensor module. The output from the sensor module may be a signal representative of (e.g. encoding) the parameter indicative of the operational temperature of the fluid fuel within the nuclear reactor. It may be that the control module is configured to cause the flow regulator to vary (e.g. increase or reduce) the operational flow rate of fluid fuel through the heat exchanger in response to determining, based on the output from the sensor module, that the operational temperature of the fluid fuel has changed. It may be that the control module is configured to cause the flow regulator to vary (e.g. increase or reduce) the operational flow rate of fluid fuel through the heat exchanger in response to determining, based on the output from the sensor module, that the operational temperature of the fluid fuel differs from a critical temperature value. For example, it may be that the control module is configured to cause the flow regulator to vary (e.g. increase or reduce) the operational flow rate of fluid fuel through the heat exchanger in response to determining, based on the output from the sensor module, that the operational temperature of the fluid fuel is above or below a critical temperature value.

It may be that the operational temperature of the fluid fuel is the temperature of the fluid fuel at the inlet to the reactor core chamber. It may be that the control module is configured to cause the flow regulator to vary (e.g. increase or reduce) the operational flow rate of fluid fuel through the heat exchanger in response to determining, based on the output from the sensor module, that the temperature at the inlet to the reactor core chamber has changed. It may be that the control module is configured to cause the flow regulator to vary (e.g. increase or reduce) the operational flow rate of fluid fuel through the heat exchanger in response to determining, based on the output from the sensor module, that the temperature of the fluid fuel at the inlet to the reactor core chamber differs from a critical inlet temperature value. For example, it may be that the control module is configured to cause the flow regulator to vary (e.g. increase or reduce) the operational flow rate of fluid fuel through the heat exchanger in response to determining, based on the output from the sensor module, that the temperature of the fluid fuel at the inlet to the reactor core chamber is above or below the critical inlet temperature value. It may be that the control module is configured to cause the flow regulator to increase the operational flow rate of fluid fuel through the heat exchanger in response to determining, based on the output from the sensor module, that the temperature of the fluid fuel at the inlet to the reactor core chamber is below the critical inlet temperature value.

The critical inlet temperature value may correspond to (e.g. may be, or may be close to (but generally above), for example within about 100° C., or about 50° C., of) a temperature at which the fluid fuel solidifies or begins to solidify. For example, the critical inlet temperature value may correspond to (e.g. may be, or may be close to (but generally above), for example within about 100° C., or about 50° C., of) the melting temperature or the freezing temperature of the fluid fuel. It will be appreciated that the freezing temperature may be lower than the melting temperature due to supercooling of the fluid fuel. It will further be appreciated that the term “melting temperature”, in embodiments in which the fluid fuel is a mixture of two or more chemically distinct species, is to be interpreted as the liquidus temperature of the fluid fuel (i.e. the temperature above which the mixture is completely liquid) and the term “freezing” temperature is to be interpreted as the solidus temperature of the fluid fuel (i.e. the temperature below which the mixture if completely solid), except for eutectic mixtures in which the liquidus and solidus temperatures are equal (and referred to as the eutectic temperature).

It may be that the sensor module is operable to measure a parameter indicative of a level of fissile material in the fluid fuel. The level of fissile material in the fluid fuel may be the total amount (e.g. mass) of fissile material in the fluid fuel circulating within the circulating-fuel nuclear reactor. Alternatively, the level of fissile material in the fluid fuel may be the concentration (e.g. measured in weight percent, volume percent, atomic percent, mass concentration, molar concentration, or any other suitable unit of concentration) of fissile material in the fluid fuel. It may be that the control module is configured to cause the flow regulator to vary (e.g. increase or reduce) the operational flow rate of fluid fuel through the heat exchanger in response to detecting a change in the level of fissile material in the fluid fuel based on an output from the sensor module. More particularly, it may be that the control module is configured to cause the flow regulator to increase the operational flow rate of fluid fuel through the heat exchanger in response to detecting a reduction in the level of fissile material in the fluid fuel based on the output from the sensor module. The output from the sensor module may be a signal representative of (e.g. encoding) the parameter indicative of the level of fissile material in the fluid fuel.

It may be that the circulating-fuel nuclear reactor comprises a clock (e.g. a timer). It may be that the control module is configured to cause the flow regulator to vary (e.g. increase or reduce) the operational flow rate of fluid fuel through the heat exchanger as a function of time, for example based on an output from the clock.

It may be that the control module is configured to cause the flow regulator to vary (e.g. increase or reduce) the operational flow rate of fluid fuel through the heat exchanger discontinuously as a function of time, i.e. to cause a discontinuous increase or discontinuous reduction in the operational flow rate of fluid fuel through the heat exchanger. For example, the control module may be configured to cause the flow regulator to affect a discrete increase or discrete reduction in the operational flow rate of fluid fuel through the heat exchanger at a predetermined point in time, or at the end of a predetermined time interval, based on the output from the clock. The discontinuous (i.e. discrete) increase or discontinuous (i.e. discrete) reduction in the operational flow rate may be effected at a time at which the operational temperature of the fluid fuel is predicted to reach a maximum or minimum allowed temperature value, for example a time at which the temperature of the fluid fuel at the inlet to the reactor core chamber is predicted to reach a minimum allowed inlet temperature value. The minimum allowed inlet temperature value may correspond to (e.g. be or be close to (but generally above), for example within about 100° C., or about 50° C., of) the melting temperature of the fluid fuel.

It may be that the control module is configured to cause the flow regulator to vary (e.g. increase or reduce) the operational flow rate of fluid fuel through the heat exchanger continuously as a function of time, i.e. to cause a continuous increase or continuous reduction in the operational flow rate of fluid fuel through the heat exchanger. The control module may be configured to cause the flow regulator to effect a continuous increase in the operational flow rate of the fluid fuel through the heat exchanger at a rate of increase determined to compensate for a predicted reduction in the level of fissile material in the fluid fuel. The control module may be configured to cause the flow regulator to affect a continuous reduction in the operational flow rate of the fluid fuel through the heat exchanger at a rate of reduction determined to compensate for a predicted increase in the level of fissile material in the fluid fuel.

The flow regulator may comprise (e.g. be) a pump (e.g. a variable pump), a valve, a flow diverter, or a conduit (e.g. a pipe) having a variable flow cross-section.

The heat exchanger may be one of a plurality of heat exchangers. The flow regulator may be one of a plurality of flow regulators. The inlet may be one of a plurality of inlets. The outlet may be one of a plurality of outlets. Accordingly, the circulating-fuel nuclear reactor may comprise a reactor core chamber having a plurality of inlets and a plurality of outlets for fluid fuel; a plurality of heat exchangers, each being configured to receive fluid fuel from the reactor core chamber via a corresponding outlet, to transfer heat from the fluid fuel, and to return the fluid fuel to the reactor core chamber via a corresponding inlet; a plurality of flow regulators, each being operable to vary the operational flow rate of fluid fuel through a corresponding heat exchanger; and a control module to control operation of the plurality of flow regulators. The control module may be configured to cause the flow regulators to vary (e.g. increase or reduce) the operational flow rate of fluid fuel through one or more of the heat exchangers to maintain an operational temperature of the fluid fuel within a predetermined range according to any method disclosed herein. It may be that each of the flow regulators is operable independent of the other flow regulators. Accordingly, in use, the operational flow rate of fluid fuel through one or more, e.g. each, of the heat exchangers may be different.

The or each heat exchanger may be configured to transfer heat from the fluid fuel to a coolant fluid such as a coolant salt. The heat exchanger may be operatively coupled to a generator for generating, for example, electricity. The coolant salt may be used to transfer heat from the heat exchanger to the generator.

It will be appreciated that, throughout this specification and the appended claims, references to varying (e.g. increasing or reducing) the operational flow rate of fluid fuel through the heat exchanger to maintain an operational temperature of the fluid fuel within the predetermined range are references to varying the operational flow rate during operation of the circulating-fuel nuclear reactor and not during start-up or shut-down of the circulating-fuel nuclear reactor, which would involve non-operational flow rates and temperatures.

The fluid fuel generally contains fissile material. The fluid fuel may comprise (e.g. be) a suspension or a solution of the fissile material. Alternatively, the fluid fuel may comprise (e.g. be) the fissile material in liquid form (e.g. molten fissile material).

The fluid fuel may be a molten fuel salt. The molten fuel salt may be a mixture of different chemical species. The molten fuel salt may comprise one or more fluoride salts. The molten fuel salt may comprise one or more of: lithium fluoride, sodium fluoride, beryllium fluoride, zirconium fluoride, potassium fluoride, rubidium fluoride.

The molten fuel salt may comprise fissile material in suspension or solution. For example, the molten fuel salt may comprise uranium-233 (i.e. ²³³U).

The molten fuel salt may comprise fertile material in suspension or solution. For example, the molten fuel salt may comprise thorium-232 (i.e. ²³²Th), thorium-233 (i.e. ²³³Th) or protactinium-233 (i.e. ²³³Pa). An example molten fuel salt comprises thorium-232 fluoride and uranium-233 fluoride dissolved in lithium fluoride, i.e. LiF-²³²ThF₄-²³³UF₄.

The molten fuel salt may be a eutectic mixture or a near-eutectic mixture.

The circulating-fuel nuclear reactor may be a Molten Salt Reactor (MSR). The circulating-fuel nuclear reactor may be an unmoderated Molten Salt Reactor (MSR). For example, the circulating-fuel nuclear reactor may be a Molten Salt Fast Reactor (MSFR). Alternatively, the circulating-fuel nuclear reactor may be a moderated Molten Salt Reactor (MSR).

According to a second aspect, there is provided a method of operating a circulating-fuel nuclear reactor, the circulating-fuel nuclear reactor comprising: a reactor core chamber having an inlet and an outlet for fluid fuel; a heat exchanger configured to receive fluid fuel from the reactor core chamber via the outlet, to transfer heat from the fluid fuel, and to return the fluid fuel to the reactor core chamber via the inlet; a flow regulator operable to vary (e.g. increase or reduce) the operational flow rate of fluid fuel through the heat exchanger; and a control module to control operation of the flow regulator; wherein the method comprises: the control module causing the flow regulator to vary (e.g. increase or reduce) the operational flow rate of fluid fuel through the heat exchanger to maintain an operational temperature of the fluid fuel within a predetermined range.

The method may comprise: the control module causing the flow regulator to vary (e.g. increase or reduce) the operational flow rate of fluid fuel through the heat exchanger, to maintain an operational temperature of the fluid fuel within a predetermined range, in response to a change in reaction conditions in the reactor core chamber. In particular, the method may comprise: the control module causing the flow regulator to vary (e.g. increase or reduce) the operational flow rate of fluid fuel through the heat exchanger (i.e. in response to the change in reaction conditions in the reactor core chamber) in order to maintain predetermined reaction conditions, for example to mitigate or to compensate for the change in reaction conditions in the reactor core chamber.

The operational temperature of the fluid fuel is generally dependent on reaction conditions in the reactor core chamber. The circulating-fuel nuclear reactor may therefore comprise a sensor module operable to measure a parameter indicative of reaction conditions in the reactor core chamber. Additionally, it may be that the method comprises: the control module causing the flow regulator to vary (e.g. increase or reduce) the operational flow rate of fluid fuel through the heat exchanger in response to detecting a change in reaction conditions in the reactor core chamber based on an output from the sensor module. The output from the sensor module may be a signal representative of (e.g. encoding) the parameter indicative of reaction conditions in the reactor core chamber. The parameter indicative of reaction conditions in the reactor core chamber may, for example, be: a temperature of the fluid fuel in the reactor core chamber, at the inlet, or at the outlet; an average temperature of the fluid fuel in the reactor chamber; a power output by the circulating-fuel nuclear reactor; an effective neutron multiplication factor, k_{eff}, or a reactivity, p; a neutron dose; a neutron flux; a fission rate in the reactor core chamber; a density of the fluid fuel circulating in the reactor; or a composition of the fluid fuel (such as a level, e.g. a concentration, of one or more components of the fluid fuel) circulating in the reactor.

The sensor module may comprise one or more of the following: a temperature sensor (e.g. a high-temperature thermocouple); a radiation detector, for example a particle detector such as a neutron detector (e.g. a proportional counter, a fission chamber such as a uranium fission chamber, a self-powered neutron detector, a MicroMegas detector, a liquid scintillation detector, an ionization chamber); a calorimeter; a mass flow rate sensor (e.g. a Coriolis flow meter, which may function as a density sensor); a volume flow rate sensor; a chemical sensor (e.g. a spectrometer).

It may be that the sensor module is operable to measure a parameter indicative of reaction kinetics in the reactor core chamber. The parameter indicative of reaction kinetics in the reactor core chamber may be a parameter indicative of, or indeed may be, the effective neutron multiplication factor, k_{eff}, or the reactivity, p. It may be that the method comprises: the control module causing the flow regulator to vary (e.g. increase or reduce) the operational flow rate of fluid fuel through the heat exchanger in response to detecting a change in the reaction kinetics (e.g. a slowdown or speedup in the nuclear reaction) in the reactor core chamber based on an output from the sensor module. For example, it may be that the method comprises: the control module causing the flow regulator to increase the operational flow rate of fluid fuel through the heat exchanger in response to detecting a slowdown in the nuclear reaction in the reactor core chamber based on an output from the sensor module. Alternatively, it may be that the control module is configured to cause the flow regulator to reduce the operational flow rate of fluid fuel through the heat exchanger in response to detecting a speedup in the nuclear reaction in the reactor core chamber based on an output from the sensor module. The output from the sensor module may be a signal representative of (e.g. encoding) the parameter indicative of reaction kinetics in the reactor core chamber.

It may be that the sensor module is operable to measure a parameter indicative of the operational temperature of the fluid fuel within the nuclear reactor. For example, it may be that the sensor module is operable to measure the operational temperature of the fluid fuel within the nuclear reactor. It may be that the method comprises: the control module causing the flow regulator to vary (e.g. increase or reduce) the operational flow rate of fluid fuel through the heat exchanger as a function of the operational temperature of the fluid fuel based on an output from the sensor module. It may be that the method comprises: the control module causing the flow regulator to vary (e.g. increase or reduce) the operational flow rate of fluid fuel through the heat exchanger in response to determining, based on an output from the sensor module, that the operational temperature of the fluid fuel has changed. It may be that the method comprises: the control module causing the flow regulator to vary (e.g. increase or reduce) the operational flow rate of fluid fuel through the heat exchanger in response to determining, based on the output from the sensor module, that the operational temperature of the fluid fuel differs from a critical temperature value. For example, it may be that the method comprises: the control module causing the flow regulator to vary (e.g. increase or reduce) the operational flow rate of fluid fuel through the heat exchanger in response to determining, based on the output from the sensor module, that the operational temperature of the fluid fuel is above or below a critical temperature value. The output from the sensor module may be a signal representative of (e.g. encoding) the parameter indicative of the operational temperature of the fluid fuel within the nuclear reactor.

It may be that the operational temperature of the fluid fuel is the temperature of the fluid fuel at the inlet to the reactor core chamber. It may be that the method comprises: the control module causing the flow regulator to vary (e.g. increase or reduce) the operational flow rate of fluid fuel through the heat exchanger in response to determining, based on an output from the sensor module, that the temperature at the inlet to the reactor core chamber has changed. It may be that the method comprises: the control module causing the flow regulator to vary (e.g. increase or reduce) the operational flow rate of fluid fuel through the heat exchanger in response to determining, based on the output from the sensor module, that the temperature of the fluid fuel at the inlet to the reactor core chamber differs from a critical inlet temperature value. For example, it may be that the method comprises: the control module causing the flow regulator to vary (e.g. increase or reduce) the operational flow rate of fluid fuel through the heat exchanger in response to determining, based on the output from the sensor module, that the temperature of the fluid fuel at the inlet to the reactor core chamber is above or below the critical inlet temperature value. It may be that the method comprises: the control module causing the flow regulator to increase the operational flow rate of fluid fuel through the heat exchanger in response to determining, based on the output from the sensor module, that the temperature of the fluid fuel at the inlet to the reactor core chamber is below the critical inlet temperature value.

The critical inlet temperature value may correspond to (e.g. may be, or may be close to (but generally above), for example within about 100° C., or about 50° C., of) a temperature at which the fluid fuel solidifies or begins to solidify. For example, the critical inlet temperature value may correspond to (e.g. may be, or may be close to (but generally above), for example within about 100° C., or about 50° C., of) the melting temperature or the freezing temperature of the fluid fuel. It will be appreciated that the freezing temperature may be lower than the melting temperature due to supercooling of the fluid fuel. It will further be appreciated that the term “melting temperature”, in embodiments in which the fluid fuel is a mixture of two or more chemically distinct species, is to be interpreted as the liquidus temperature of the fluid fuel (i.e. the temperature above which the mixture is completely liquid) and the term “freezing” temperature is to be interpreted as the solidus temperature of the fluid fuel (i.e. the temperature below which the mixture if completely solid), except for eutectic mixtures in which the liquidus and solidus temperatures are equal (and referred to as the eutectic temperature).

It may be that the sensor module is operable to measure a parameter indicative of a level of fissile material in the fluid fuel. The level of fissile material in the fluid fuel may be the total amount (e.g. mass) of fissile material in the fluid fuel circulating within the circulating-fuel nuclear reactor. Alternatively, the level of fissile material in the fluid fuel may be the concentration (e.g. measured in weight percent, volume percent, atomic percent, mass concentration, molar concentration, or any other suitable unit of concentration) of fissile material in the fluid fuel. It may be that the method comprises: the control module causing the flow regulator to vary (e.g. increase or reduce) the operational flow rate of fluid fuel through the heat exchanger in response to detecting a change in the level of fissile material in the fluid fuel based on an output from the sensor module. More particularly, it may be that the method comprises: the control module causing the flow regulator to increase the operational flow rate of fluid fuel through the heat exchanger in response to detecting a reduction in the level of fissile material in the fluid fuel based on the output from the sensor module. The output from the sensor module may be a signal representative of (e.g. encoding) the parameter indicative of the level of fissile material in the fluid fuel.

It may be that the circulating-fuel nuclear reactor comprises a clock (e.g. a timer). It may be that the method comprises: the control module causing the flow regulator to vary (e.g. increase or reduce) the operational flow rate of fluid fuel through the heat exchanger as a function of time, for example based on an output from the clock.

It may be that the method comprises: the control module causing the flow regulator to vary (e.g. increase or reduce) the operational flow rate of fluid fuel through the heat exchanger discontinuously as a function of time, i.e. to cause a discontinuous increase in the operational flow rate of fluid fuel through the heat exchanger. For example, it may be that the method comprises: the control module causing the flow regulator to affect a discrete increase or discrete reduction in the operational flow rate of fluid fuel through the heat exchanger at a predetermined point in time, or at the end of a predetermined time interval, based on the output from the clock. The method may comprise: effecting the discontinuous (i.e. discrete) increase or discontinuous (i.e. discrete) reduction in the operational flow rate at a time at which the operational temperature of the fluid fuel is predicted to reach a maximum or minimum allowed temperature value, for example a time at which the temperature of the fluid fuel at the inlet to the reactor core chamber is predicted to reach a minimum allowed inlet temperature value. The minimum allowed inlet temperature value may correspond to (e.g. be or be close to (but generally above), for example within about 100° C., or about 50° C., of) the melting temperature of the fluid fuel.

It may be that the method comprises: the control module causing the flow regulator to vary (e.g. increase or reduce) the operational flow rate of fluid fuel through the heat exchanger continuously as a function of time, i.e. to cause a continuous increase or continuous reduction in the operational flow rate of fluid fuel through the heat exchanger. It may be that the method comprises: the control module causing the flow regulator to affect a continuous increase in the operational flow rate of the fluid fuel through the heat exchanger at a rate of increase determined to compensate for a predicted reduction in the level of fissile material in the fluid fuel. It may be that the method comprises: the control module causing the flow regulator to affect a continuous reduction in the operational flow rate of the fluid fuel through the heat exchanger at a rate of reduction determined to compensate for a predicted increase in the level of fissile material in the fluid fuel.

The flow regulator may comprise (e.g. be) a pump (e.g. a variable pump), a valve, a flow diverter, or a conduit (e.g. a pipe) having a variable flow cross-section.

The heat exchanger may be one of a plurality of heat exchangers. The flow regulator may be one of a plurality of flow regulators. The inlet may be one of a plurality of inlets. The outlet may be one of a plurality of outlets. Accordingly, the circulating-fuel nuclear reactor may comprise a reactor core chamber having a plurality of inlets and a plurality of outlets for fluid fuel; a plurality of heat exchangers, each being configured to receive fluid fuel from the reactor core chamber via a corresponding outlet, to transfer heat from the fluid fuel, and to return the fluid fuel to the reactor core chamber via a corresponding inlet; a plurality of flow regulators, each being operable to vary the operational flow rate of fluid fuel through a corresponding heat exchanger; and a control module to control operation of the plurality of flow regulators. The method may comprise: the control module causing the flow regulators to vary (e.g. increase or reduce) the operational flow rate of fluid fuel through one or more of the heat exchangers to maintain an operational temperature of the fluid fuel within a predetermined range, according to any method disclosed herein. It may be that each of the flow regulators is operable independent of the other flow regulators. Accordingly, the operational flow rate of fluid fuel through one or more, e.g. each, of the heat exchangers may be different.

The fluid fuel generally contains fissile material. The fluid fuel may comprise (e.g. be) a suspension or a solution of the fissile material. Alternatively, the fluid fuel may comprise (e.g. be) the fissile material in liquid form (e.g. molten fissile material).

The fluid fuel may be a molten fuel salt. The molten fuel salt may be a mixture of different chemical species. The molten fuel salt may comprise one or more fluoride salts. The molten fuel salt may comprise one or more of: lithium fluoride, sodium fluoride, beryllium fluoride, zirconium fluoride, potassium fluoride, rubidium fluoride, uranium fluoride, thorium fluoride.

The molten fuel salt may comprise fissile material in suspension or solution. For example, the molten fuel salt may comprise uranium-233 (i.e. ²³³U), for example in ionic form (i.e. as a salt).

The molten fuel salt may comprise fertile material in suspension or solution. For example, the molten fuel salt may comprise thorium-232 (i.e. ²³²Th), thorium-233 (i.e. ²³³Th) or protactinium-233 (i.e. ²³³Pa), for example in ionic form (i.e. as a salt). An example molten fuel salt comprises thorium-232 fluoride and uranium-233 fluoride dissolved in lithium fluoride, i.e. LiF-²³²ThF₄-²³³UF₄.

The molten fuel salt may be a eutectic mixture or a near-eutectic mixture.

The circulating-fuel nuclear reactor may be a Molten Salt Reactor (MSR). The circulating-fuel nuclear reactor may be an unmoderated Molten Salt Reactor (MSR). For example, the circulating-fuel nuclear reactor may be a Molten Salt Fast Reactor (MSFR). Alternatively, the circulating-fuel nuclear reactor may be a moderated Molten Salt Reactor (MSR).

According to a third aspect there is provided a computer program comprising instructions to cause a control module of a circulating-fuel nuclear reactor to carry out any method according to the second aspect.

According to a fourth aspect there is provided a non-transitory computer-readable medium storing, or a data carrier signal carrying, the computer program according to the third aspect.

The skilled person will appreciate that, except where mutually exclusive, a feature described in relation to any one of the above aspects may be applied mutatis mutandis to any other aspect. Furthermore, except where mutually exclusive, any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a schematic illustration of a Molten Salt Fast Reactor (MSFR);

FIG. 2 is a schematic cross-section through a portion of a reactor core chamber of the MSFR of FIG. 1;

FIG. 3 is a schematic illustration of a control module of the MSFR in communication with a computer readable memory;

FIG. 4 is a schematic illustration of a method of operating an MSFR;

FIG. 5 is a plot of inlet temperature (Tᵢₙ) and outlet temperature (Tₒᵤₜ) of molten fuel salt flowing through the inlet and outlet of the reactor core chamber, as a function of time, as calculated for a model MSFR operating under two different fractions of a nominal molten fuel salt flow rate;

FIG. 6 is a plot of inlet temperature (Tᵢₙ) and outlet temperature (Tₒᵤₜ), and the effective neutron multiplication factor (k_{eff}), as a function of molten fuel salt flow rate in a model MSFR;

FIG. 7 is a plot of inlet temperature (Tᵢₙ), outlet temperature (Tₒᵤₜ) and average reactor core chamber temperature (T_{average}) as a function of time for a model MSFR subjected to a step increase in molten fuel salt flow rate; and

FIG. 8 is a plot of the fraction of nominal power output by a model MSFR as a function of molten fuel salt flow rate expressed as a fraction of a nominal fuel salt flow rate.

### DETAILED DESCRIPTION OF THE DISCLOSURE

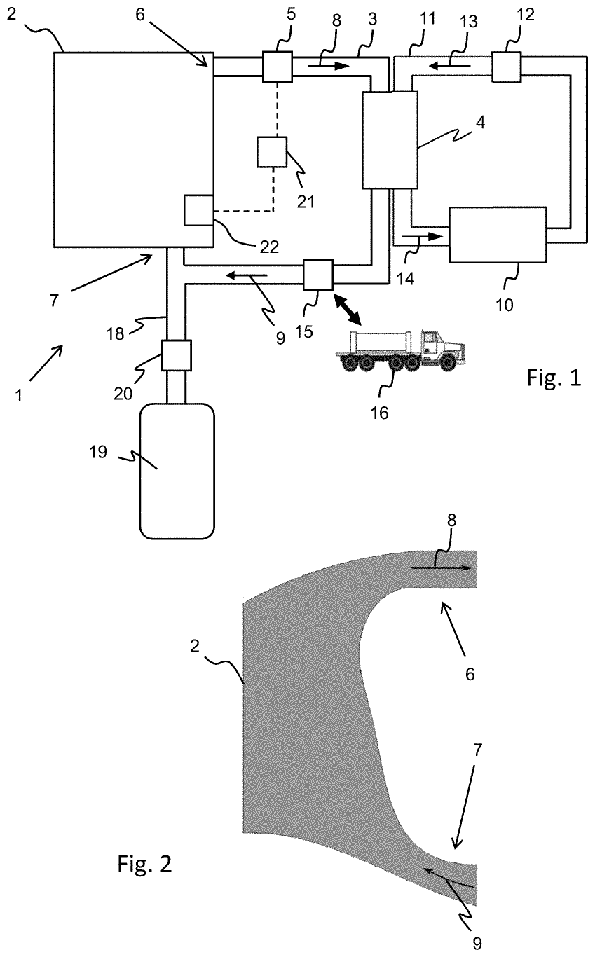

FIG. 1 provides a schematic illustration of a Molten Salt Fast Reactor (MSFR) 1, which is an example of a circulating-fuel nuclear reactor. The MSFR includes a reactor core chamber 2 for receiving molten fuel salt (i.e. a fluid fuel) containing fissile material for sustaining a nuclear chain reaction. The reactor core chamber 2 is in fluid communication, by way of pipes 3, with a heat exchanger 4 such that molten fuel salt may be transferred between the reactor core chamber 2 and the heat exchanger 4. The MSFR 1 further includes a variable flow rate pump 5 for pumping molten fuel salt from the reactor core chamber 2 out of the reactor core chamber 2 at an outlet 6, through the heat exchanger 4, and back into the reactor core chamber 2 at an inlet 7, around a reactor flow loop indicated generally by arrows 8 and 9. In other examples, the pump may be located at any position within the flow loop.

The MSFR 1 also includes a generator heat exchanger 10 in fluid communication, by way of pipes 11, with the heat exchanger 4. A pump 12 is provided for pumping coolant salt from the generator heat exchanger 10, through the heat exchanger 4, and back to the generator heat exchanger 10, around a generator heat exchange flow loop indicated generally by arrows 13 and 14. The heat exchanger 4 operates to transfer heat from the molten fuel salt in the reactor flow loop to the coolant salt in the generator heat exchange flow loop for subsequent transfer by the generator heat exchanger 10 to a generator (not shown) for generating electricity.

A reactor flow loop access point 15 is provided between the heat exchanger 4 and the reactor core chamber 2, the access point being accessible for extracting fuel salt from the reactor flow loop for transfer to a chemical processing plant (indicated by transfer vehicle 16) and for introducing fresh or processed fuel salt and/or fissile material into the reactor flow loop.

An emergency escape pipe 18 connects the reactor flow loop to emergency dump tank 19 by way of a freeze plug 20. The freeze plug 20 is made of solidified fuel salt and normally blocks passage of molten fuel salt from the reactor flow loop to the emergency dump tank.

The MSFR 1 is an example of a Molten Salt Reactor (MSR). In an example of use, molten fuel salt having a composition of LiF(77.5%)-HNF(22.35%), where HNF are heavy nuclei fluorides including fissile uranium-233 (²³³U) and fertile thorium-232 (²³²Th), is pumped through the reactor core chamber 2 and around the reactor flow loop as indicated in FIG. 1. Although in the simplified diagram of FIG. 1 only one inlet, one outlet and one heat exchanger are shown, in practice there may be a plurality of heat exchangers (for example twelve or sixteen) angularly arranged around the reactor core chamber 2. Each of the plurality of heat exchangers may be connected to a single inlet and a single outlet located, respectively, above and below the reactor core chamber 2, or instead each of the plurality of heat exchangers may be connected to a respective one of a plurality of inlets evenly spaced around the reactor core chamber 2 towards its bottom end and a respect one of a plurality of outlets evenly spaced around the reactor chamber 2 towards its top end. Each heat exchanger may be associated with an individually-controllable variable flow pump for pumping molten fuel salt out of the reactor core chamber from the corresponding outlet, through the heat exchanger, and back into reactor core chamber through the corresponding inlet. For example, each heat exchanger may be a 187 MWth heat exchanger and each pump may be configured to pump molten fuel salt, under normal conditions, at a nominal flow rate of about 0.1 to about 2.5 m³/s, such that the transition period of the fuel salt inside the reactor core chamber (not including time spent travelling through the heat exchangers) is about 2 to about 35 s. Nominal flow rates as low as about 0.04 m³/s or as high as about 7 m³/s may be achievable in alternative MSR designs, with reactor core chamber transition periods up to about 60 s.

When in operation, as the molten fuel salt passes through the reactor core chamber 2 (shown in more detail in FIG. 2), fissile material (in particular uranium-233) in the salt undergoes nuclear fission, releasing heat. Accordingly, the temperature of the molten fuel salt tends to increase as it travels through the reactor core chamber 2 from the inlet 7 to the outlet 6. As the molten fuel salt is pumped through the heat exchanger 4, heat is transferred from the molten fuel salt to the coolant salt pumped around the generator heat exchange flow loop. The generator heat exchanger 10 transfers heat from the coolant salt to the generator, where it is used to heat water to generate steam and drive a turbine (not shown), thereby generating electricity.

In the MSFR, neutron absorber or moderator rods (such as control rods) are not available for controlling the nuclear reaction in the event of an inadvertent speedup in the reaction rate. Use of control rods, in particular, in a circulating-fuel nuclear reactor is undesirable because they obstruct fuel salt circulation and increase the number of structural components subjected to irradiation. Instead of control rods, three methods of controlling criticality in the MSFR reactor core chamber have been proposed up to now.

The first criticality control method which has been proposed is passive criticality control through the strong negative temperature coefficient of reactivity, α_{T}, of the molten fuel salt. Since α_{T} is negative, an increase in fuel salt temperature tends to lead to a reduction in effective neutron multiplication factor, k_{eff}, which in turn leads to a reduction in neutron flux and therefore a reduction in reactor power. As the reactor power reduces, so does the fuel salt temperature. Accordingly, the MSFR is considered to be an inherently safe reactor design, as small fluctuations in temperature are self-correcting and k_{eff} tends to stabilise at a value of 1.

The second criticality control method which has been proposed is fuel salt reprocessing. As the nuclear reaction proceeds, fissile material in the fuel salt is used up and fission products are generated. The main fission products generated in the MSFR are noble gases and soluble fission products such as soluble lanthanides, which are considered to be neutron poisoning isotopes since they (due to their relatively large neutron absorption cross-sections) absorb neutrons generated on fission which could otherwise go on to cause new fission events. In fuel salt reprocessing, noble gases are removed from the molten fuel salt by bubbling helium gas through the salt, while soluble fission products are removed by pyrochemical processing.

Fuel salt reprocessing, by removing neutron poisoning isotopes, can be used to increase k_{eff}, compensating for the reduction in k_{eff} which would otherwise occur as fission products build up in the system and the fissile material is depleted. k_{eff} can also be increased by introduction of new fissile material at the access point 15. Alternatively, k_{eff} can be reduced by deliberately introducing non-fissile salts, or lower enrichment fuel salts, into the reactor at the access point 15.

However, fuel salt reprocessing is carried out in a chemical processing plant which, although it may be located onsite, requires extraction of molten fuel salt from the reactor flow loop through the access point 15 prior to processing, as well as reintroduction of fresh fuel salt back into the reactor flow loop. A continuous supply and handling of active isotopes is therefore required. Such a mechanism may therefore be unsuitable for use in emergency situations, or in the event of a failure of the chemical plant or unavailability of fresh fissile isotopes.

The third criticality control mechanism which has been proposed is provided by the melt plug 20 formed from solidified fuel salt. In the event of the core overheating, the melt plug 20 melts and allows fuel salt to escape from the reactor core chamber 2 into the drain tank 19 under gravity. The drain tank is air cooled and has a deeply subcritical geometry such that the nuclear reaction in the tank is suppressed. This method therefore only provides criticality control in extreme situations when the reactor overheats. An additional drawback of this method of criticality control is that, in the event that the melt plug 20 melts, the reactor core chamber 2 requires refueling before it is possible to restart the nuclear reaction.

In addition to being configured to implement the three criticality control mechanisms described hereinabove, the MSFR of the present invention also provides a fourth criticality control mechanism in the form of the variable flow rate pump 5. This new control mechanism is based on the discovery that the flow rate of molten fuel salt around the reactor flow loop has a direct effect on the temperature of the fuel salt. In particular, and as explained in more detail below, increasing the flow rate of molten fuel salt around the reactor flow loops tends to cause an increase in the temperature of molten fuel salt entering the reactor core chamber 2 at the inlet 7 and a reduction in the temperature of molten fuel salt exiting the reactor core chamber 2 at the outlet 6. In contrast, reducing the flow rate of molten fuel salt around the reactor flow loops tends to cause a reduction in the temperature of molten fuel salt entering the reactor core chamber 2 at the inlet 7 and an increase in the temperature of molten fuel salt exiting the reactor core chamber 2 at the outlet 6. Accordingly, adjustment of the flow rate of molten fuel salt around the reactor flow loop can be used to compensate for changes in the reaction conditions in the reactor core chamber which result in changes in the temperature of the fuel salt in different locations in the reactor.

As shown in FIG. 1, the MSFR 1 is provided with a control module 21 operatively connected to the variable flow rate pump 5. The control module 21 is configured to control operation of the variable flow rate pump 5 so as to vary the flow rate at which molten fuel salt flows out of the reactor core chamber 2, through the heat exchanger 4, and back into the reactor core chamber 2, around the reactor flow loop. In particular, the control module 21 is configured to operate the variable flow rate pump 5 to vary the flow rate at which molten fuel salt flows around the reactor flow loop to maintain an operational temperature of the fuel salt within a predetermined range. Accordingly, the control module 21 is able to maintain criticality by adjusting the molten fuel salt flow rate in response to changes in the reaction conditions in the reactor core chamber (such as changes in the reaction kinetics, which may be characterised by k_{eff} or ρ, changes in the temperature of the fuel salt at any given location, or changes in the amount of fissile material circulating within the nuclear reactor).

In order to detect changes in the reaction conditions, the MSFR 1 includes a sensor module 22. In the particular embodiment shown in FIG. 1, the sensor module 22 includes a temperature sensor operable to measure the temperature of molten fuel salt entering the reactor core chamber 2 at the inlet 7. The temperature sensor may be a temperature sensor of any type known in the field, for example a high-temperature thermocouple. The control module 21 is operatively connected to the sensor module 22 for receiving measurements of the temperature of the molten fuel salt at the inlet 7. In alternative embodiments, the sensor module 22 may include any type of sensor suitable for measuring parameters indicative of the nuclear reaction conditions in the reactor core chamber 2, such as a neutron detector (e.g. a proportional counter, a fission chamber such as a uranium fission chamber, a self-powered neutron detector, a MicroMegas detector, a liquid scintillation detector or an ionization chamber), a calorimeter, a mass flow rate sensor (e.g. a Coriolis flow meter, which may function as a density sensor), a volume flow rate sensor, or a chemical sensor such as a spectrometer, and the control module 21 may be operatively connected to the sensor module 22 for receiving measurements of the said parameters. Conditions in the generator heat exchange flow loop may also be indicative of the reaction conditions since the heat transfer to the generator heat exchange flow loop is a function of the reaction conditions and the flow rate through the heat exchanger. Accordingly, in some examples, the sensor module may be provided in the generator heat exchange flow loop or in the generator and may be configured to monitor a temperature, pressure or dryness fraction at any particular location around the flow loop, or a power output or rotary speed of the generator.

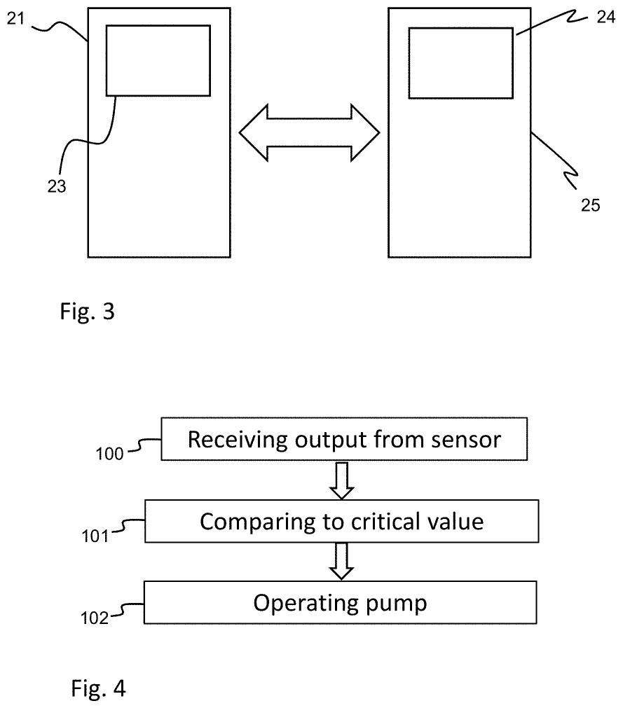

In the embodiment shown in FIG. 1, the control module 21 is configured to control operation of the variable flow rate pump 5 in response to measurements output by the sensor module 22. In particular, the control module 21 is configured to control operation of the variable flow rate pump 5 in response to measurements of the temperature of the molten fuel salt at the inlet 7 received from the sensor module 22. In more detail, as shown schematically in FIG. 3, the control module 21 includes a processor 23 in communication with a computer readable medium 25 containing computer executable program instructions 24 for controlling operation of the variable flow rate pump 5 differently dependent on the measurements received from the sensor module 22.

As outlined in FIG. 4, the control module is configured: to receive an output from the sensor module 22 indicative of the temperature of the molten fuel salt at the inlet 7 (block 100); to compare the temperature of the molten fuel salt at the inlet 7 to a critical inlet temperature value (block 101); and, if the temperature of the molten fuel salt at the inlet 7 is less than the critical inlet temperature value, to operate the variable flow rate pump 5 (block 102) to increase the flow rate of molten fuel salt around the reactor flow loop, thereby increasing the temperature of the molten fuel salt at the inlet. By setting the critical inlet temperature value close to the melting temperature (T_{M}) of the fuel salt (for example, to a value of T_{M}+50° C.), solidification of the fuel salt at the inlet 7 can be avoided.

The particular details of the control algorithm implemented by the control module 2 will depend on the parameter measured by the sensor module 22. For example, in embodiments in which the sensor module 22 contains a temperature sensor operable to measure the temperature of the molten fuel salt at the outlet 6, the control module 2 may be configured: to receive an output from the sensor module 22 indicative of the temperature of the molten fuel salt at the outlet 6; to compare the temperature of the molten fuel salt at the outlet 6 to a critical outlet temperature value; and, if the temperature of the molten fuel salt at the outlet 6 is greater than the critical outlet temperature value, to operate the variable flow rate pump 5 to increase the flow rate of molten fuel salt around the reactor flow loop, thereby reducing the temperature of the molten fuel salt at the outlet 6 and increasing the temperature of the molten fuel salt at the inlet 7. The critical outlet temperature value may be a predetermined function of the flow rate and heat exchanger conditions, such as the temperature of the fluid acting as a heat sink in the heat exchanger.

The control module 21 may be configured to operate the variable flow rate pump 5 to increase or reduce the flow rate of molten fuel salt around the reactor flow loop in response to measurements, provided by the sensor module 22, of any parameters indicative of changes in the reaction conditions in the reactor core chamber 2, in order to directly or indirectly maintain the operating temperature within a predetermined range, and thereby avoid supercriticality or freezing of the fuel salt within the reactor. A control procedure which features temperature in the feedback loop or objective function may be considered to directly maintain the operating temperature, whereas control procedures based on other parameters related to the reaction conditions and thereby indirectly related to the operational temperature, may be considered to be methods of indirectly maintaining the operating temperature. Accordingly, it will be appreciated that operational temperature need not be directly monitored in a control procedure in order to be maintained within a predetermined range.

In some embodiments, the control module 2 may be configured to operate the variable flow rate pump 5 independently of any output from the sensor module 22. For example, the control module 2 may include a clock (not shown) and the control module 2 may be configured to operate the variable flow rate pump 5 to increase the flow rate of the molten fuel salt around the reactor flow loop continuously or discontinuously as a function of time. A continuous increase in the flow rate of the molten fuel salt as the reactor operates may be used to compensate for a predicted continuous decrease in the amount of fissile material circulating within the reactor as the fissile material is used up in the nuclear reaction. Alternatively, a discontinuous (i.e. discrete or step-change) increase in the flow rate of the molten fuel salt may be used to increase the temperature of the molten fuel salt at the inlet 7 at a time at which it is predicted that the temperature of the molten fuel salt will fall below the critical inlet temperature value. In such examples, the operational temperature may be predictable as a function of time, such that a control procedure based only on time may be configured to maintain the operational temperature within a predetermined range.

FIGS. 4 to 8 provide examples of the effect of varying molten fuel salt flow rate in a model MSFR. These results are based on neutronics and thermal-hydraulics coupled calculations using the neutronics simulation code SERPENT-2, which is based on three-dimensional continuous-energy Monte Carlo reactor physics burnup methods (see, for example, J. Leppänen. Serpent—a Continuous-energy Monte Carlo Reactor Physics Burnup Calculation Code. VTT Technical Research Centre of Finland (Jun. 18, 2015)), and the generic thermal-hydraulics solver OpenFOAM® (available from The OpenFOAM Foundation Ltd, England).

The model MSFR included a reactor core chamber 2.5 m in height and 1.25 m in radius connected to sixteen heat exchanger loops. The power output was 1 GWe (at 40% thermodynamic efficiency) and the operating temperature was (630° C.). The fuel salt was LiF—ThF₄—UF₄, having a melting temperature of 565° C., a density of 4.3 g/cm³ at 630° C. and a temperature-independent specific heat capacity of 1391 J/kgK, and including 22 mol. % of heavy nuclear (ThF₄ and UF₄) with 3 mol. % ²³³U. The reactor contained 20 m³ of fuel salt. The fuel cycle period was 6.8 s and, for each cycle of fuel salt, the time spent in the reactor core chamber was 3.4 s and the time spent in the heat exchangers was 3.4 s. The heat exchangers were designed to pump the fuel salt at a nominal flow rate of 3.61 m³/s. The fuel salt temperature at the inlet to the reactor core chamber was calculated based on the average outlet temperature and the flow rate. If the outlet temperature and the flow rate were not sufficient provide 3 GW power output, the inlet temperature was assumed to be 850 K, above the melting temperature of the fuel salt (823 K).

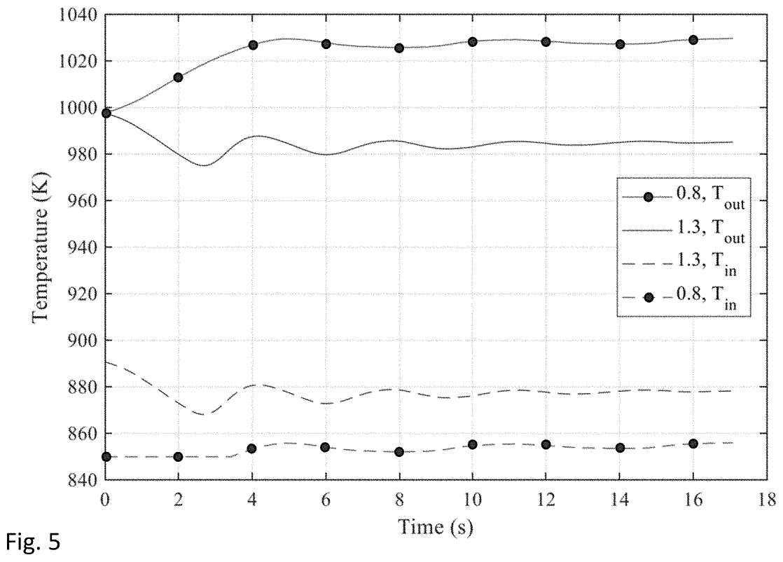

FIG. 5 shows the temperature of the fuel salt calculated at the inlet and the outlet of the reactor core chamber as a function of time following a reduction (lines with circles) and an increase (unmarked lines) in the flow rate of the fuel salt through the heat exchangers relative to the nominal flow rate. In particular, the flow rate was reduced to 0.8 of the nominal value and increased to 1.3 of the nominal value. As can be seen from FIG. 5, reducing the flow rate leads to an increase in the temperature at the reactor core chamber outlet and a reduction in the temperature at the reactor core chamber inlet. In contrast, increasing the flow rate leads to a reduction in the temperature at the outlet and an increase in the temperature at the inlet.

These results can be understood as follows. The temperature of the fuel salt increases as it passes through the reactor chamber core due to fission reactions. When the fuel salt is circulated at a lower flow rate, it spends more time in the core and, therefore, more time fissioning. Consequently, the temperature of the fuel salt is increased as it passes through the core chamber relative to fuel salt flowing at the nominal flow rate. Accordingly, the outlet temperature increases. At the same time, since the flow rate is the same in the core chamber and in the heat exchangers, at lower flow rates, the fuel salt spends more time in the heat exchangers in contact with coolant salt and so more heat is transferred from the fuel salt to the generator heat exchange flow loop. This leads to a reduction in the temperature of the fuel salt leaving each heat exchanger at the corresponding inlet to the core chamber.

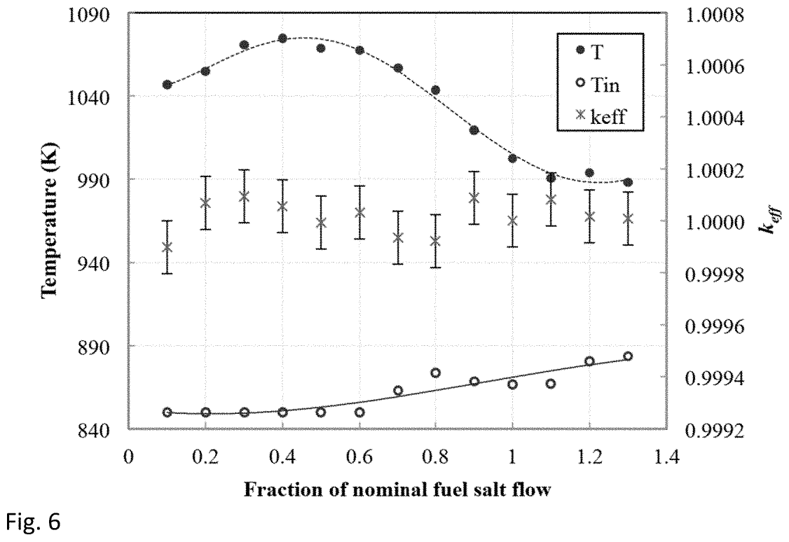

Since the fuel salt has a negative temperature coefficient of reactivity, fluctuations in k_{eff}, and thus fluctuations in the temperature, tend to reduce over time. This is confirmed by FIG. 6 which shows that k_{eff} tends to stabilise around a value of 1 despite large changes in the fuel salt flow rate.

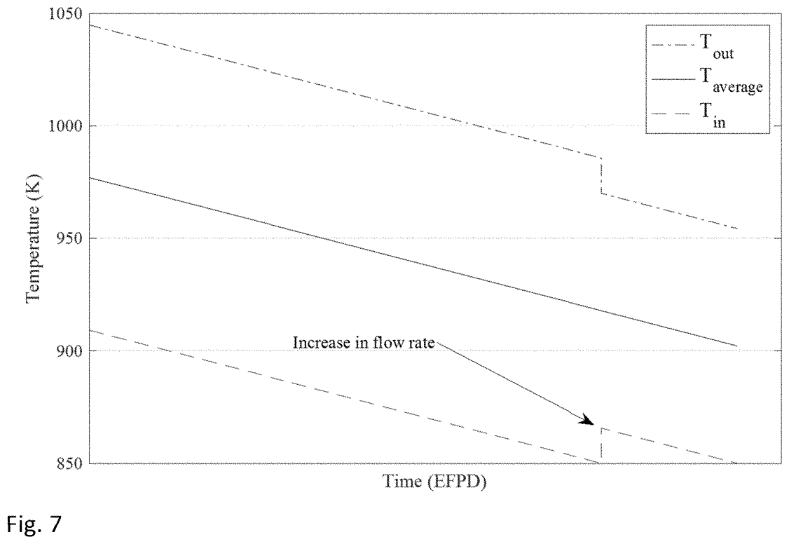

As the amount of fissile material in the fuel salt is used up, a decrease in k_{eff} is generally observed. As the nuclear reaction slows down, the average temperature in the reactor core chamber decreases, as shown in FIG. 7. Given constant conditions in the generator heat exchange flow loop, both the inlet and the outlet temperatures fall at the same rate. If the outlet temperature is allowed to drop below the melting temperature of the fuel salt, the salt will solidify, and the power output from the reactor will drop until fresh fissile material can be added or the fuel can be chemically reprocessed.

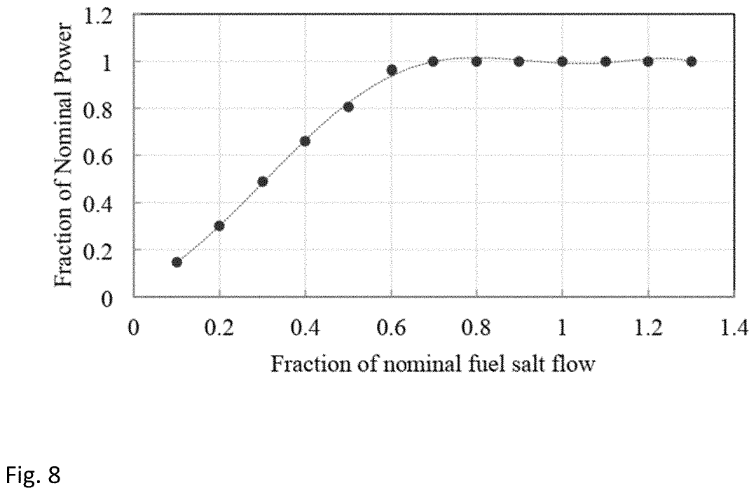

However, as shown in FIG. 7, a discrete increase in fuel salt flow rate (by 30% relative to the nominal flow rate) as the melting temperature is approached results in an increase in the inlet temperature, such that solidification of the fuel salt is delayed until such time as reprocessing or replacement of fuel is feasible. The lifetime of the reaction can therefore be extended by controlling the flow rate of the fuel salt. In addition, the results shown in FIG. 8 indicate that nominal power output can be maintained for constant fuel salt flow rates from about 0.7 to 1.3 of nominal flow rate. Similar behaviour at higher flow rates is expected. At very low flow rates (below about 70% of nominal flow rate), the suppression of k_{eff} due to the increased temperature results in a reduced power output.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A circulating-fuel nuclear reactor comprising:
a reactor core chamber having an inlet and an outlet for fluid fuel;
a heat exchanger configured to receive fluid fuel from the reactor core chamber via the outlet, to transfer heat from the fluid fuel, and to return the fluid fuel to the reactor core chamber via the inlet;
a flow regulator operable to vary an operational flow rate of fluid fuel through the heat exchanger; and
a control module configured to cause the flow regulator to vary the operational flow rate of fluid fuel through the heat exchanger to maintain an operational temperature of the fluid fuel within a predetermined range.

2. The circulating-fuel nuclear reactor according to claim 1, wherein the operational temperature of the fluid fuel is dependent on reaction conditions in the reactor core chamber, wherein the circulating-fuel nuclear reactor (1) further comprises a sensor module operable to measure a parameter indicative of reaction conditions in the reactor core chamber, and wherein the control module is configured to cause the flow regulator to vary the operational flow rate of fluid fuel through the heat exchanger in response to detecting a change in reaction conditions in the reactor core chamber based on an output from the sensor module.

3. The circulating-fuel nuclear reactor according to claim 2, wherein the sensor module is operable to measure a parameter indicative of reaction kinetics in the reactor core chamber, and wherein the control module is configured to cause the flow regulator to vary the operational flow rate of fluid fuel through the heat exchanger in response to detecting a slowdown or a speedup in the nuclear reaction in the reactor core chamber based on an output from the sensor module.

4. The circulating-fuel nuclear reactor according to claim 2, wherein the sensor module is operable to measure a parameter indicative of the operational temperature of the fluid fuel within the nuclear reactor, and wherein the control module is configured to cause the flow regulator to vary the operational flow rate of fluid fuel through the heat exchanger in response to determining, based on an output from the sensor module, that the operational temperature of the fluid fuel is above or below a critical temperature value.

5. The circulating-fuel nuclear reactor according to claim 4, wherein the operational temperature is the temperature of the fluid fuel at the inlet to the reactor core chamber, and wherein the control module is configured to cause the flow regulator to increase the operational flow rate of fluid fuel through the heat exchanger in response to determining, based on the output from the sensor module, that the temperature of the fluid fuel at the inlet is below a critical inlet temperature value.

6. The circulating-fuel nuclear reactor according to claim 2, wherein the sensor module is operable to measure a parameter indicative of a level of fissile material in the fluid fuel, and wherein the control module is configured to cause the flow regulator to increase the operational flow rate of fluid fuel through the heat exchanger in response to detecting a reduction in the level of fissile material in the fluid fuel based on an output from the sensor module.

7. The circulating-fuel nuclear reactor according to claim 1, wherein the circulating-fuel nuclear reactor comprises a clock, and wherein the control module is configured to cause the flow regulator to vary the operational flow rate of fluid fuel through the heat exchanger as a function of time.

8. A method of operating a circulating-fuel nuclear reactor, the circulating-fuel nuclear reactor comprising:
a reactor core chamber having an inlet and an outlet for fluid fuel;
a heat exchanger configured to receive fluid fuel from the reactor core chamber via the outlet, to transfer heat from the fluid fuel, and to return the fluid fuel to the reactor core chamber via the inlet;
a flow regulator operable to vary the operational flow rate of fluid fuel through the heat exchanger; and
a control module to control operation of the flow regulator;
wherein the method comprises:
the control module causing the flow regulator to vary the operational flow rate of fluid fuel through the heat exchanger to maintain an operational temperature of the fluid fuel within a predetermined range.

9. The method according to claim 8, wherein the operational temperature of the fluid fuel is dependent on reaction conditions in the reactor core chamber, wherein the circulating-fuel nuclear reactor comprises a sensor module operable to measure a parameter indicative of reaction conditions in the reactor core chamber, and the method comprises:
the control module causing the flow regulator to vary the operational flow rate of fluid fuel through the heat exchanger in response to detecting a change in reaction conditions in the reactor core chamber based on an output from the sensor module.

10. The method according to claim 9, wherein the sensor module is operable to measure a parameter indicative of reaction kinetics in the reactor core chamber, and the method comprises:
the control module causing the flow regulator to vary the operational flow rate of fluid fuel through the heat exchanger in response to detecting a slowdown or a speedup in the nuclear reaction in the reactor core chamber based on an output from the sensor module.

11. The method according to claim 8, wherein the sensor module is operable to measure a parameter indicative of the operational temperature of the fluid fuel within the nuclear reactor, and the method comprises:
the control module causing the flow regulator to vary the operational flow rate of fluid fuel through the heat exchanger in response to determining, based on an output from the sensor module, that the operational temperature of the fluid fuel is above or below a critical temperature value.

12. The method according to claim 11, wherein the operational temperature is the temperature of the fluid fuel at the inlet to the reactor core chamber, and the method comprises:
the control module causing the flow regulator to increase the operational flow rate of fluid fuel through the heat exchanger in response to determining, based on the output from the sensor module, that the temperature of the fluid fuel at the inlet is below a critical inlet temperature value.

13. The method according to claim 8, wherein the circulating-fuel nuclear reactor comprises a clock and the method comprises:
the control module causing the flow regulator to vary the operational flow rate of fluid fuel through the heat exchanger as a function of time.

14. The circulating-fuel nuclear reactor according to claim 1, wherein the fluid fuel is a molten fuel salt.

15. The method according to claim 8, wherein the fluid fuel is a molten fuel salt.

16. A computer program comprising instructions to cause a control module of a circulating-fuel nuclear reactor to carry out the method according to claim 8.

17. A non-transitory computer-readable medium storing, or a data carrier signal carrying, the computer program according to claim 16.
